(19) United States
(12) Patent Application Publication
(10) Pub. No.: US 2026/0256560 A1
(43) Pub. Date: Sep. 3, 2026

(54) SYSTEMS AND METHODS FOR FABRICATING ORTHODONTIC RETAINERS

(71) Applicant: LUXCREO INC., Chicago, IL (US)

(72) Inventor: Sudhanva Raj GOVINDARAJAN, Chicago, IL (US)

(73) Assignee: LUXCREO INC., Chicago, IL (US)

(21) Appl. No.: 19/656,958

(22) Filed: Apr. 23, 2026

Related U.S. Application Data
(63) Continuation of application No. PCT/US2024/052460, filed on Oct. 22, 2024.
(60) Provisional application No. 63/592,562, filed on Oct. 23, 2023.

(51) Int. Cl. A61C 13/34; B33Y 40/20; B33Y 50/02; B33Y 80/00

(52) U.S. Cl. CPC A61C 13/34; B33Y 40/20; B33Y 50/02; B33Y 80/00

(57) ABSTRACT

The present disclosure provides systems and methods for fabricating an orthodontic retainer comprising a retainer base. The methods may include obtaining a first digital model representing the palate and the upper teeth of a patient. The methods may include creating, based on the first digital model, a second digital model representing the retainer base and a third digital model representing a teeth shell, and creating, based on the second digital model and the third digital model, a fourth digital model representing the retainer base and the teeth shell that are connected via a connecting structure. The methods may include generating a printed assembly by printing the fourth digital model using a first curable resin material. The printed assembly may at least include the retainer base, the teeth shell, and the connecting structure. The methods may include post-processing the printed assembly to obtain the retainer base.

### CROSS-REFERENCE TO RELATED APPLICATIONS

This application is a continuation of International Application No. PCT/US 2024/052460, filed on Oct. 22, 2024, which claims priority to U.S. Provisional Patent Application No. 63/592,562, filed on Oct. 23, 2023, the contents of which are hereby incorporated by reference.

### TECHNICAL FIELD

The present disclosure generally relates to the field of three-dimensional (3D) printing, and more particularly, relates to systems and methods for fabricating orthodontic retainers through 3D printing techniques.

### BACKGROUND

An orthodontic retainer is an orthodontic appliance designed to maintain the alignment of teeth after orthodontic treatment or teeth-straightening procedures. The primary function of the orthodontic retainer is to stabilize the teeth in their adjusted/orthodontic positions, ensuring proper jaw alignment and preserving the long-term results of the orthodontic treatment.

However, the conventional fabrication of the orthodontic retainer, such as a “salt and pepper” process, is a cumbersome and labor-intensive process that requires skilled technicians and is time-intensive due to the multiple stages involved, including teeth model preparation, material mixing, adapting, curing, final polishing, etc. The labor-intensive nature of the “salt and pepper” process also introduces the potential for human error, leading to inefficiencies and inconsistencies in the final product.

Therefore, it is desirable to provide systems and methods for fabricating orthodontic retainers, which can automatically fabricate the orthodontic retainers to improve the efficiency of the orthodontic retainer fabrication.

### SUMMARY

In an aspect of the present disclosure, a method for orthodontic appliance production is provided. The method may be implemented on a computing device having at least one processor and at least one storage device. The method may include obtaining a first digital model representing the palate and the upper teeth of a patient. The method may also include creating a second digital model representing the retainer base and a third digital model representing a teeth shell based on the first digital model and creating a fourth digital model representing the retainer base and the teeth shell that are connected via a connecting structure based on the second digital model and the third digital model. The method may include generating a printed assembly by printing the fourth digital model using a first curable resin material. The printed assembly may at least include the retainer base, the teeth shell, and the connecting structure. The method may further include post-processing the printed assembly to obtain the retainer base.

In another aspect of the present disclosure, a system for orthodontic appliance production is provided. The system may include at least one storage device including a set of instructions and at least one processor configured to communicate with the at least one storage device. When executing the set of instructions, the at least one processor may be configured to direct the system to perform following operations. The operations may include obtaining a first digital model representing the palate and the upper teeth of a patient. The operations may also include creating a second digital model representing the retainer base and a third digital model representing a teeth shell based on the first digital model and creating a fourth digital model representing the retainer base and the teeth shell that are connected via a connecting structure based on the second digital model and the third digital model. The operations may include generating a printed assembly by printing the fourth digital model using a first curable resin material. The printed assembly may at least include the retainer base, the teeth shell, and the connecting structure. The operations may further include post-processing the printed assembly to obtain the retainer base.

In still another aspect of the present disclosure, a non-transitory computer readable medium is provided. The medium may include executable instructions that, when executed by at least one processor, direct the at least one processor to perform a method for orthodontic appliance production. The method may include obtaining a first digital model representing the palate and the upper teeth of a patient. The method may also include creating a second digital model representing the retainer base and a third digital model representing a teeth shell based on the first digital model and creating a fourth digital model representing the retainer base and the teeth shell that are connected via a connecting structure based on the second digital model and the third digital model. The method may include generating a printed assembly by printing the fourth digital model using a first curable resin material. The printed assembly may at least include the retainer base, the teeth shell, and the connecting structure. The method may further include post-processing the printed assembly to obtain the retainer base.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary system for fabricating an orthodontic retainer according to some embodiments of the present disclosure;

FIG. 2 is a block diagram illustrating an exemplary processing device according to some embodiments of the present disclosure;

FIG. 3 is a flowchart illustrating an exemplary process for fabricating an orthodontic retainer according to some embodiments of the present disclosure;

FIG. 4A is a schematic diagram illustrating an exemplary first digital model according to some embodiments of the present disclosure;

FIG. 4B is a schematic diagram illustrating the second digital model and the third digital model in FIG. 4A seen from another perspective according to some embodiments of the present disclosure;

FIG. 4C is a schematic diagram illustrating an exemplary second digital model and an exemplary third digital model according to some embodiments of the present disclosure;

FIG. 4D is a schematic diagram illustrating an exemplary fourth digital model according to some embodiments of the present disclosure;

FIG. 4E is a schematic diagram illustrating an exemplary fourth digital model seen from another perspective according to some embodiments of the present disclosure;

FIG. 4F is a schematic diagram illustrating an exemplary retainer base according to some embodiments of the present disclosure;

FIG. 5 is a flowchart illustrating an exemplary process for creating a second digital model representing a retainer base according to some embodiments of the present disclosure;

FIG. 6 is a schematic diagram illustrating an exemplary correction path of an upper tooth according to some embodiments of the present disclosure;

FIG. 7 is a schematic diagram illustrating an exemplary process for generating a printed assembly according to some embodiments of the present disclosure;

FIGS. 8A and 8B are schematic diagram illustrating exemplary fifth digital models including second digital element representing support structures according to some embodiments of the present disclosure;

FIG. 9A is a schematic diagram illustrating an exemplary fifth digital model including a fourth digital element representing an internal structure according to some embodiments of the present disclosure;

FIG. 9B is a schematic diagram illustrating an exemplary fifth digital model including a fifth digital element representing an extended base according to some embodiments of the present disclosure;

FIG. 9C is a schematic diagram illustrating an exemplary fifth digital model including a sixth digital element representing an anchor support according to some embodiments of the present disclosure;

FIG. 10 is a schematic diagram illustrating an exemplary process for fabricating an orthodontic retainer according to some embodiments of the present disclosure; and

FIG. 11 is a schematic diagram illustrating an exemplary computing device according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention.

Spatial and functional relationships between elements (for example, between layers) are described using various terms, including “connected,” “engaged,” “interfaced,” and “coupled.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between” versus “directly between,” “adjacent” versus “directly adjacent,” etc.).

Spatial related terms, such as “below,” “lower,” “lower part,” “above,” “upper part,” etc., are used herein to describe relationship between elements or components shown in the drawings and one or more other elements or components. It should be understood that, in addition to the orientation depicted in the drawings, the spatially related terms are also intended to include different orientations of the device in use or operation. For example, if a device in the drawings is reversed, elements described as “below” or “beneath” other elements or components will be oriented “above” the other elements or components. Thus, the exemplary term “below” can include both an orientation of above and below. The device can be oriented in other ways (rotated by 90 degrees or other orientations) and correspondingly interpret the spatially related descriptors used herein. Similarly, unless explicitly indicated otherwise, the terms “upward,” “downward,” “vertical,” “horizontal,” etc. are used herein for explanation only.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The oral environment, including teeth, is dynamic in nature. After orthodontic treatment, there is a tendency for the teeth to shift back toward their original positions (or their pre-treatment positions) from their adjusted/orthodontic positions, a phenomenon known as relapse. An orthodontic retainer prevents the relapse by maintaining the teeth in the orthodontic positions. Additionally, the orthodontic retainer aids in the adaptation of the periodontal ligament, and assists in reshaping and stabilizing the gums and bone structures around the treated teeth. The orthodontic retainer supports these oral structures as they adjust to the orthodontic positions and undergo the healing process.

The orthodontic retainer comes in various forms, including removable and fixed types, and is custom-made from several different materials based on their designs. A specific type and a use duration of the orthodontic retainer are often determined by the orthodontist, tailored to the patient's individual needs. The orthodontic retainer includes a Hawley retainer, a clear plastic retainer (also referred to as an Essix retainer), a fixed or bonded retainer, or the like, or any combination thereof.

The Hawley retainer, named after its inventor Dr. Charles Hawley, is one of the oldest and most well-known types of orthodontic retainers. The Hawley retainer is a removable retainer commonly used after the orthodontic treatment to maintain the orthodontic positions of the teeth and prevent the relapse. The Hawley retainer includes two main parts: a metal wire part (e.g., a metal wire) that typically surrounds the six anterior teeth to hold them in place, and a plastic or acrylic body (i.e., a retainer base) that holds the metal wire part in place and rests against the roof of the mouth or along the lingual surfaces of the teeth. The retainer base not only ensures that the Hawley retainer fits comfortably in the patient's mouth but also provides durability and stability to maintain proper tooth alignment.

In terms of function, the Hawley retainer not only maintains the orthodontic positions of the teeth after the orthodontic treatment, but also allows for minor correction of the orthodontic positions of the teeth due to the adjustability of the metal wire part. For example, the metal wire part can be adjusted to make minor refinements to tooth positioning.

The clear plastic retainer is made from clear plastic, such as, Invisalign® aligners. The clear plastic retainer does not have a metal wire part and is less visible than the Hawley retainer.

The fixed or bonded retainer comprises a metal wire part that is bonded or glued to the lingual (back) surfaces of the teeth. The fixed or bonded retainer is employed in cases where there is a high risk of teeth, particularly the lower front teeth, reverting to their pre-treatment positions.

Compared to the clear plastic retainer, the Hawley retainer offers enhanced durability due to its metal and acrylic structure. In addition, the Hawley retainer allows for the adjustability in the tooth positioning. Another advantage is that the Hawley retainer does not cover the occlusal surfaces of the teeth, which facilitates natural tooth settling.

Compared to the fixed or bonded retainer, the Hawley retainer is removable, allowing for easier maintenance of oral hygiene. Additionally, the Hawley retainer requires less patient compliance compared to other removable options.

Therefore, the Hawley retainer is a versatile and effective tool during the retention phase of the orthodontic treatment.

Traditionally, a fabrication process of the Hawley retainer begins with creating a model of the patient's teeth, which is manually adjusted to correct minor tooth position anomalies. Once the model accurately reflects the desired tooth alignment, the fabrication of the Hawley retainer commences. Initially, a layer of release membrane is applied to the model. In some cases, a second layer is added to facilitate easy separation. Each layer requires several minutes of curing. A lab technician then adapts a wire framework onto the teeth model. An acrylic portion of the Hawley retainer is formed using a “salt and pepper” manner, which is a layer-by-layer manual sculpting process. A polymer powder (“salt”) is applied beneath the metal wire, followed by the application of a liquid monomer (“pepper”) over the top. This process is repeated layer by layer until a 2.5-3 millimeters (mm) buildup of the acrylic is achieved. The lab technician then adjusts the acrylic around the metal wire parts using specialized instruments. The mixture undergoes a curing period to harden into its final form. After the curing, excess material is trimmed and polished to provide a finished appearance of the Hawley retainer and ensure a comfortable fit between the Hawley retainer and the patient.

Therefore, the conventional fabrication process of the Hawley retainer is a highly manual process that requires skilled technicians and is time-intensive due to the multiple stages. The labor-intensive nature of the conventional fabrication process also introduces the potential for human error, leading to inefficiencies and inconsistencies in the final product.

In order to solve the above problems, the present disclosure provides systems and methods for fabricating an orthodontic retainer comprising a retainer base. The methods may include obtaining a first digital model representing the palate and the upper teeth of a patient. The methods may also include creating a second digital model representing the retainer base and a third digital model representing a teeth shell based on the first digital model and creating a fourth digital model representing the retainer base and the teeth shell that are connected via a connecting structure based on the second digital model and the third digital model. The methods may include generating a printed assembly by printing the fourth digital model using a first curable resin material. The printed assembly may at least include the retainer base, the teeth shell, and the connecting structure. The methods may further include post-processing the printed assembly to obtain the retainer base. As a result, the retainer base can be fabricated automatically, reducing manual labor and thereby improving the efficiency of the orthodontic retainer fabrication. In addition, by using the first curable resin material, the properties of the retainer base can be improved, so that a thickness and/or a weight of the retainer base are reduced, thereby improving the user experience. Furthermore, by introducing the first digital model, no physical model needs to be fabricated for the palate and the upper teeth of the patient, which can further reduce manual labor and improve the efficiency of model fabrication.

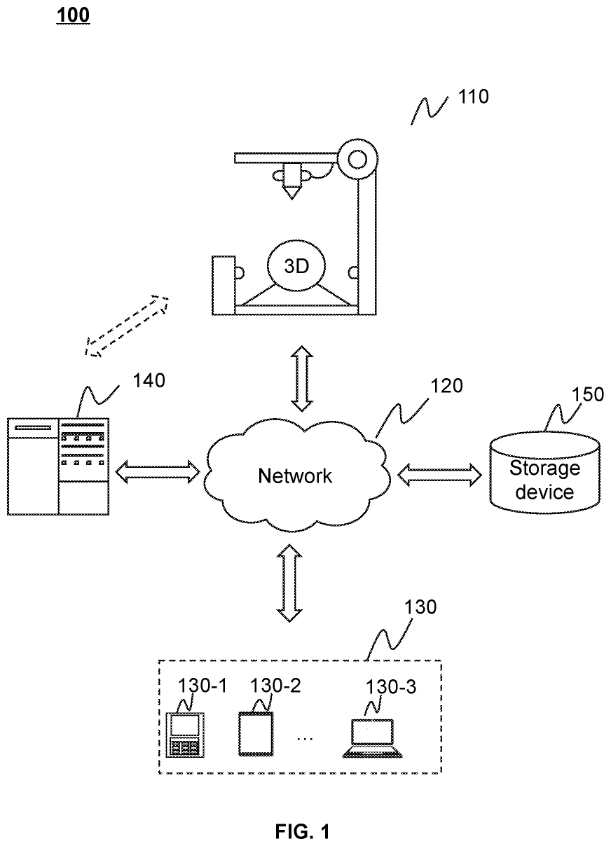

FIG. 1 is a schematic diagram illustrating an exemplary system 100 for fabricating an orthodontic retainer according to some embodiments of the present disclosure.

As illustrated in FIG. 1, the system 100 for fabricating the orthodontic retainer may include a 3D printer 110, a network 120, at least one terminal device 130, a processing device 140, and a storage device 150. The components of the system 100 may be connected in one or more of various ways. For example, the 3D printer 110 may be connected to the processing device 140 through the network 120. As another example, the 3D printer 110 may be connected to the processing device 140 directly (as indicated by the bi-directional arrow in dotted lines linking the 3D printer 110 and the processing device 140).

The 3D printer 110 may be configured to produce a 3D object (e.g., an orthodontic retainer) by processing printing materials based on instructions from the processing device 140. For example, the 3D printer 110 may generate a printed assembly by printing a fourth digital model using a printing material (e.g., a first curable resin material). In some embodiments, the printing material may include a plastic material, a resin material (e.g., the first curable resin material, a second curable resin material), a metal material, a rubber material, a wax material, or the like, or any combination thereof. For example, the printing materials may be a resin material including thermal-curing components and photocurable components. The photocurable components may be cured by light beams and the thermal-curing components may be cured in a heating process. In some embodiments, the 3D printer 110 may be any type of printer. Exemplary types may include a digital light processing (DLP) printer, a liquid crystal display (LCD) printer, a stereo lithography (SLA) printer, a polymer jetting printer, a selective laser sintering (SLS) printer, a selective laser melting (SLM) printer, an electron beam melting (EBM) printer, a fused deposition modeling (FDM) printer, a layer laminate manufacturing (LLM) printer, an aerosol printer, a bioplotter printer, or the like, or any combination thereof.

The network 120 may include any suitable network that can facilitate the exchange of information and/or data for the system 100. In some embodiments, one or more components (e.g., the 3D printer 110, the at least one terminal device 130, the processing device 140, the storage device 150) of the system 100 may communicate with one or more other components of the system 100 via the network 120. In some embodiments, the network 120 may be any type of wired or wireless network, or a combination thereof. Merely by way of example, the network 120 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 120 may include one or more network access points. For example, the network 120 may include wired and/or wireless network access points such as base stations and/or internet exchange points through which one or more components of the system 100 may be connected to the network 120 to exchange data and/or information.

The at least one terminal device 130 may include a mobile device 130-1, a tablet computer 130-2, a laptop computer 130-3, or the like, or any combination thereof. In some embodiments, the mobile device 130-1 may include a smart home device, a wearable device, a smart mobile device, a virtual reality device, an augmented reality device, or the like, or any combination thereof.

In some embodiments, the 3D printer 110 and/or the processing device 140 may be remotely operated through the at least one terminal device 130. In some embodiments, the 3D printer 110 and/or the processing device 140 may be operated through the at least one terminal device 130 via a wireless connection. In some embodiments, the at least one terminal device 130 may receive information and/or instructions inputted by a user and send the received information and/or instructions to the 3D printer 110 or the processing device 140 via the network 120. In some embodiments, the at least one terminal device 130 may receive data and/or information from the processing device 140. In some embodiments, the at least one terminal 130 may provide a user interface via which a user may view information and/or input data and/or instructions to the system 100. For example, the at least one terminal 130 may include a display that can display information in a human-readable form, such as text, image, audio, video, graph, animation, or the like, or any combination thereof. The display of the at least one terminal 130 may include a cathode ray tube (CRT) display, a liquid crystal display (LCD), a light-emitting diode (LED) display, a plasma display panel (PDP), a three-dimensional (3D) display, or the like, or any combination thereof. In some embodiments, the at least one terminal device 130 may be part of the processing device 140. In some embodiments, the at least one terminal device 130 may be omitted.

The processing device 140 may process data and/or information obtained from the 3D printer 110, the at least one terminal device 130, and/or the storage device 150. For example, the processing device 140 may obtain a first digital model representing the palate and the upper teeth of a patient. As another example, the processing device 140 may create a second digital model representing the retainer base and a third digital model representing a teeth shell based on the first digital model and create a fourth digital model representing the retainer base and the teeth shell that are connected via a connecting structure based on the second digital model and the third digital model. As still another example, the processing device 140 may direct the 3D printer 110 to generate the printed assembly by printing the fourth digital model using the first curable resin material. The printed assembly may at least include the retainer base, the teeth shell, and the connecting structure.

In some embodiments, the processing device 140 may be a single server or a server group. The server group may be centralized or distributed. In some embodiments, the processing device 140 may be local or remote. For example, the processing device 140 may access information and/or data stored in or acquired by the 3D printer 110, the at least one terminal device 130, and/or the storage device 150 via the network 120. As another example, the processing device 140 may be directly connected to the 3D printer 110, the at least one terminal device 130, and/or the storage device 150 to access stored or acquired information and/or data. In some embodiments, the processing device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 140 may be integrated into the 3D printer 110.

The storage device 150 may store data and/or instructions. In some embodiments, the storage device 150 may store data obtained from the 3D printer 110, the at least one terminal device 130, and/or the processing device 140. For example, the storage device 150 may store the digital models (e.g., the first digital model, the second digital model, the third digital model, the fourth digital model, etc.). In some embodiments, the storage device 150 may store data and/or instructions that the processing device 140 may execute or use to perform exemplary methods described in the present disclosure. In some embodiments, the storage device 150 may include a mass storage device, a removable storage device, a volatile read-and-write memory, a read-only memory (ROM), or the like, or any combination thereof. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components (e.g., the 3D printer 110, the processing device 140, the at least one terminal device 130) of the system 100. One or more components of the system 100 may access the data or instructions stored in the storage device 150 via the network 120. In some embodiments, the storage device 150 may be directly connected to or communicate with one or more components (e.g., the 3D printer 110, the processing device 140, the at least one terminal device 130) of the system 100. In some embodiments, the storage device 150 may be part of the processing device 140.

In some embodiments, the system 100 may further include other component(s) (e.g., one or more power supplies, a 3D scanner, etc.) connected to one or more components (e.g., the 3D printer 110, the processing device 140, the at least one terminal device 130, the storage device 150) of the system 100.

It should be noted that the above description is merely provided for the purposes of illustration, and is not intended to limit the scope of the present disclosure. For persons having ordinary skills in the art, multiple variations and modifications may be made under the teachings of the present disclosure. Features, structures, methods, and other characteristics of the exemplary embodiments described herein may be combined in various ways to obtain additional and/or alternative exemplary embodiments. However, those variations and modifications do not depart from the scope of the present disclosure.

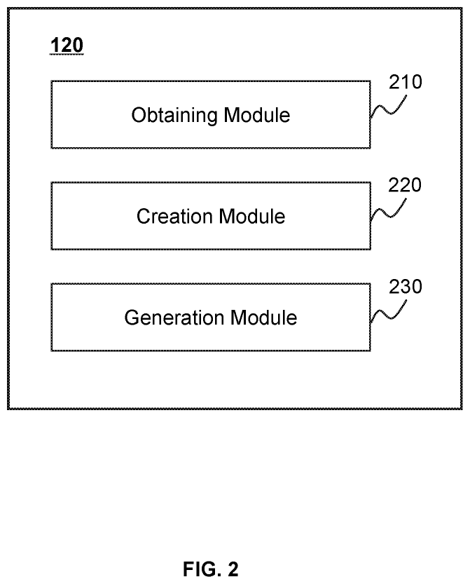

FIG. 2 is a block diagram illustrating an exemplary processing device 140 according to some embodiments of the present disclosure. In some embodiments, the processing device 140 may be in communication with a computer-readable storage medium (e.g., the storage device 150 illustrated in FIG. 1) and may execute instructions stored in the computer-readable storage medium. The processing device 140 may include an obtaining module 210, a creation module 220, and a generation module 230.

The obtaining module 210 may be configured to obtain a first digital model representing the palate and the upper teeth of a patient. More descriptions regarding the obtaining of the first digital model may be found elsewhere in the present disclosure. See, e.g., operation 302 and relevant descriptions thereof.

The creation module 220 may be configured to create a second digital model representing the retainer base and a third digital model representing a teeth shell. More descriptions regarding the creation of the second digital model and the third digital model may be found elsewhere in the present disclosure. See, e.g., operation 304 and relevant descriptions thereof.

The creation module 220 may be further configured to create a fourth digital model representing the retainer base and the teeth shell that are connected via a connecting structure based on the second digital model and the third digital model. The connecting structure refers to a structure configured to connect the retainer base and the teeth shell. More descriptions regarding the creation of the fourth digital model may be found elsewhere in the present disclosure. See, e.g., operation 306 and relevant descriptions thereof.

The generation module 230 may be configured to generate a printed assembly by printing the fourth digital model using a first curable resin material. The first curable resin material refers to a curable resin material used to print the fourth digital model. More descriptions regarding the generation of the printed assembly may be found elsewhere in the present disclosure. See, e.g., operation 308 and relevant descriptions thereof.

It should be noted that the above descriptions of the processing device 140 are provided for the purposes of illustration, and not intended to limit the scope of the present disclosure. For persons having ordinary skills in the art, various variations and modifications may be conducted under the guidance of the present disclosure. However, those variations and modifications do not depart from the scope of the present disclosure. In some embodiments, the processing device 140 may include one or more other modules. For example, the processing device 140 may include a storage module to store data generated by the modules in the processing device 140. In some embodiments, any two of the modules may be combined as a single module, and any one of the modules may be divided into two or more units. For example, the creation module 220 may include a first creation unit and a second creation unit, wherein the first creation unit may be configured to create the second digital model and the third digital model, and the second creation unit may be configured to create the fourth digital model.

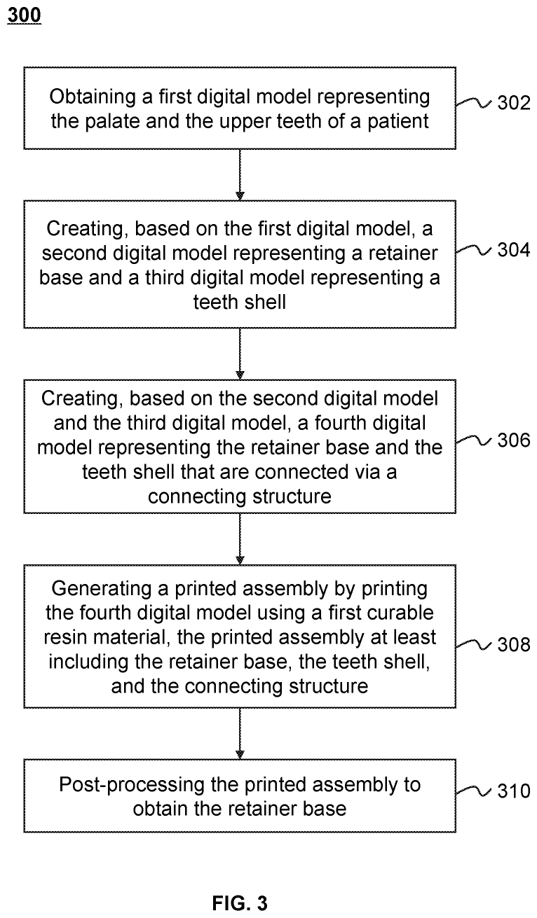

FIG. 3 is a flowchart illustrating an exemplary process 300 for fabricating an orthodontic retainer according to some embodiments of the present disclosure.

In 302, a first digital model representing the palate and the upper teeth of a patient may be obtained. In some embodiments, operation 302 may be performed by the processing device 140 (e.g., the obtaining module 210).

The patient refers to a subject whose teeth need to maintain in target positions. For example, the patient may be a person who has received an orthodontic treatment and needs to wear an orthodontic retainer to maintain the teeth in orthodontic positions after the orthodontic treatment.

The orthodontic retainer refers to a dental appliance for maintaining the teeth in the orthodontic positions and preventing relapse. In some embodiments, the orthodontic retainer may include a retainer base that provides structural support for the orthodontic retainer. More descriptions regarding the orthodontic retainer may be found elsewhere in the present disclosure.

For illustration purposes, the following descriptions are described with reference to a Hawley retainer including a retainer base. It should be noted that the Hawley retainer is merely provided for illustration, and is not intended to limit the scope of the present disclosure. The orthodontic retainer may be any orthodontic retainer that is capable to maintain the teeth in the orthodontic positions and prevent the relapse, such as, a clear plastic retainer, a fixed or bonded retainer, etc.

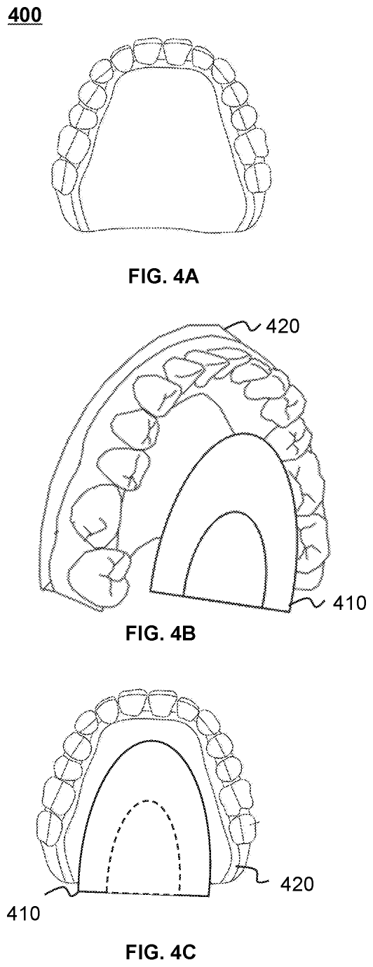

A digital model is a virtual representation of a physical object, system, process, etc., created using digital technology. The first digital model may be a 3D digital model representing the palate and the upper teeth of the patient. For example, referring to FIG. 4A, a model 400 is an exemplary first digital model representing the palate and the upper teeth of a patient.

In some embodiments, the processing device 140 may generate the first digital model based on image data of the palate and the upper teeth of the patient. For example, image data of the teeth and the upper teeth of the patient may be acquired by scanning (e.g., performing a scan of a physical impression or an intraoral scan on) the teeth and the upper teeth of the patient, and the first digital model may be constructed based on the image data using a construction software system. Exemplary construction software systems may include LuxCreo's LuxDesign software, 3Shape TRIOS software, CEREC Primescan software, iTero Element software, or the like, or any combination thereof. As another example, the first digital model may be obtained through cone beam computed tomography (CBCT) or photogrammetry technology.

In some embodiments, the processing device 140 may obtain the first digital model from a storage device (e.g., the storage device 150, a database, or an external storage) that stores the first digital model or from a scanning device that scans the palate and the upper teeth of the patient.

By introducing the first digital model, no physical model needs to be fabricated for the palate and the upper teeth of the patient, which can reduce manual labor and improve the efficiency of model fabrication. In addition, through the digital technology, the first digital model can be easily adjusted according to actual needs (e.g., orthodontic requirements, patient preferences, etc.), thereby improving the accuracy and efficiency of the orthodontic retainer fabrication.

In 304, a second digital model representing the retainer base and a third digital model representing a teeth shell may be created based on the first digital model. In some embodiments, operation 304 may be performed by the processing device 140 (e.g., the creation module 220).

As described above, the retainer base is a plastic or acrylic body that holds a metal wire part in place and rests against the roof of the mouth or along the lingual surfaces of the teeth. The teeth shell refers to a thin, custom-made covering or shell that is placed over surfaces of the teeth. The teeth shell is used during the fabrication stage to provide structural support for the retainer base, guaranteeing accuracy of the retainer base during printing and post-processing. In the meantime, the retainer base serves as structural support for the surrounding teeth shell as well, helping accuracy of the entire model. In the post-processing, the teeth shell will be removed, and only the retainer base will be used by the patient.

The second digital model may be a 3D digital model corresponding to the retainer base, and the third digital model may be a 3D digital model corresponding to the teeth shell. Merely by way of example, referring to FIGS. 4B and 4C, FIG. 4B is a schematic diagram illustrating an exemplary second digital model 410 and an exemplary third digital model 420 according to some embodiments of the present disclosure. FIG. 4C is a schematic diagram illustrating the second digital model 410 and the third digital model 420 seen from another perspective according to some embodiments of the present disclosure.

In some embodiments, the processing device 140 may create the second digital model representing the retainer base based on the first digital model. For example, the processing device 140 may create the second digital model by fitting the palate in the first digital model through processing software. Exemplary processing software may include LuxCreo's LuxDesign software, SolidWorks, Blender, Fusion 360, Meshmixer, or the like, or any combination thereof. Merely by way of example, the processing device 140 may import the first digital model into the processing software, and the processing software may determine a shape of the second digital model by fitting the palate in the first digital model, and create the second digital model based on the shape of the second digital model.

In some embodiments, the processing device 140 may create a second digital model representing a retainer base with a uniform thickness. In some embodiments, the processing device 140 may create a second digital model representing a retainer base with a non-uniform thickness. For example, at locations where the teeth are more inclined to move back to their original positions, the retainer base can have a locally thicker part to provide more orthodontic force. As another example, areas of the retainer base that are prone to plastic creep may be reinforced, while areas covering the lingual side of the maxillar teeth can be thinner. For instance, a center of the retainer base may be thicker than edges of the retainer base.

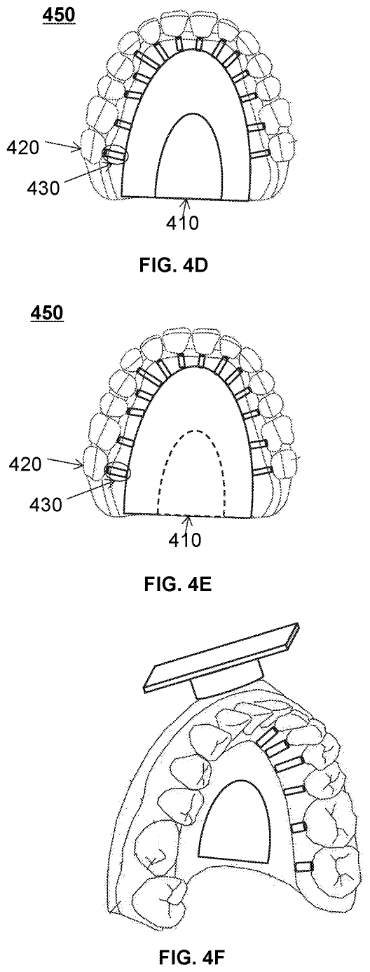

In some embodiments, the processing device 140 may determine first thicknesses of the retainer base corresponding to the upper teeth to create the second digital model representing the retainer base. The first thicknesses of the teeth shell corresponding to an upper tooth refers to the thickness of a portion of the retainer base close to the upper tooth. The first thicknesses of the teeth shell corresponding to different upper teeth may be the same or different. For example, the processing device 140 may determine a relapse probability of each upper tooth based on tooth characteristics of the upper tooth. The tooth characteristics may at least include one or more characteristics relating to a correction path of the upper tooth. Further, the processing device 140 may determine the first thicknesses of the retainer base corresponding to the upper teeth based on the relapse probability of each upper tooth, and generate the second digital model based on the first thicknesses of the retainer base. For instance, the processing device 140 may import the first digital model and the first thicknesses of the retainer base into the processing software, and the processing software may create the second digital model with the first thicknesses by fitting the palate in the first digital model. More descriptions regarding the generation of the second digital model based on the first thicknesses of the retainer base may be found elsewhere in the present disclosure (e.g., FIG. 5 and the descriptions thereof).

In some embodiments, the processing device 140 may create an initial digital model representing a surrounding teeth part based on the first digital model, and create the third digital model representing the teeth shell by hollowing the initial digital model. For example, after the processing device 140 imports the first digital model into the processing software, the processing software may obtain the initial digital model representing the surrounding teeth part by removing a portion corresponding to the palate in the first digital model, and create the third digital model by hollowing the initial digital model.

In some embodiments, the processing device 140 may determine second thicknesses of the teeth shell corresponding to the upper teeth to create the third digital model by hollowing the initial digital model based on the second thicknesses of the teeth shell. In some embodiments, the second thicknesses of the teeth shell may be at a millimeter level. For example, the second thicknesses of the teeth shell may be within a range from 0.1 mm to 4.0 mm. As another example, the second thicknesses of the teeth shell may be within a range from 0.6 mm to 4.0 mm. As still another example, the second thicknesses of the teeth shell may be within a range from 0.2 mm to 3.0 mm. As yet another example, the second thicknesses of the teeth shell may be within a range from 0.3 mm to 2.0 mm. As yet another example, the second thicknesses of the teeth shell may be within a range from 0.4 mm to 1.0 mm. As yet another example, the second thicknesses of the teeth shell may be within a range from 0.6 mm to 0.9 mm.

The second thicknesses of the teeth shell corresponding to an upper tooth refers to the thickness of a portion of the teeth shell close to the upper tooth. The second thicknesses of the teeth shell corresponding to different upper teeth may be the same or different. In some embodiments, the processing device 140 may determine the second thicknesses of the teeth shell based on an empirical value. For example, the processing device 140 may determine the empirical value based on historical data, and designate the empirical value as the second thicknesses of the teeth shell. In some embodiments, the processing device 140 may determine the second thicknesses of the teeth shell based on an input of a user (e.g., a doctor). For example, the second thicknesses of the teeth shell may be input by the user via a user terminal.

In some embodiments, the processing device 140 may determine the second thicknesses of the teeth shell corresponding to the upper teeth based on the first thicknesses of the retainer base corresponding to the upper teeth, and create the third digital model by hollowing the initial digital model based on the second thicknesses of the teeth shell. Since the teeth shell serves as structural support for the retainer base, a thicker teeth shell is needed to provide enough structural support for a thicker retainer base. Therefore, the second thickness of the teeth shell corresponding to an upper tooth has a positive relationship with the first thickness of the retainer base corresponding to the upper tooth. For example, the processing device 140 may determine a corresponding relationship between reference second thicknesses of the teeth shell and reference first thicknesses of the retainer base, and determine the second thicknesses of the teeth shell based on the first thicknesses of the retainer base and the corresponding relationship. Merely by way of example, the processing device 140 may create a table, a graph, etc., indicating the corresponding relationship based on historical data. When a first thickness of the retainer base corresponding to a certain upper tooth is obtained, the processing device 140 may retrieve the table, the graph, etc., to determine the second thickness of the teeth shell corresponding to the upper tooth based on the first thickness of the retainer base corresponding to the upper tooth.

As another example, the processing device 140 may determine initial second thicknesses of the teeth shell based on the first thicknesses of the retainer base corresponding to the upper teeth, and normalize the initial second thicknesses of the teeth shell into a reference range to determine the second thicknesses. The reference range refers to an appropriate range that satisfies fabrication requirements (e.g., a strength/supporting requirement, an efficiency requirement, etc.). For example, the reference range may be the range from 0.6 mm to 0.9 mm. By setting the reference range, the second thicknesses of the teeth shell can be determined in the appropriate range, which can ensure the teeth shell to support the retainer base, and save materials for fabricating the teeth shell, thereby improving the efficiency of the fabrication of the teeth shell.

In 306, a fourth digital model representing the retainer base and the teeth shell that are connected via a connecting structure may be created based on the second digital model and the third digital model. In some embodiments, operation 306 may be performed by the processing device 140 (e.g., the creation module 220).

The connecting structure refers to a structure configured to connect the retainer base and the teeth shell. For example, the connecting structure may include connecting rods, connecting channels, etc.

The fourth digital model may be a 3D digital model including the retainer base, the teeth shell, and the connecting structure. Merely by way of example, referring to FIGS. 4D and 4E, FIG. 4D is a schematic diagram illustrating an exemplary fourth digital model 450 according to some embodiments of the present disclosure. FIG. 4E is a schematic diagram illustrating the fourth digital model 450 seen from another perspective according to some embodiments of the present disclosure. FIG. 4D shows the occlusal side of the fourth digital model, and FIG. 4E shows the basal side of the fourth digital model that contacts with the patient's palate. As illustrated in FIGS. 4D and 4E, in the fourth digital model 450, the second digital model 410 representing the retainer base and the third digital model 420 representing the teeth shell are connected via digital models 430 representing connecting rods.

In some embodiments, the connecting structure includes multiple connecting rods that are evenly or unevenly spaced or distributed. For example, a distance between two adjacent connecting rods may be within a range from 0.7 to 5.0 mm. As another example, the distance between two adjacent connecting rods may be within a range from 1.0 to 4.0 mm. As still another example, the distance between two adjacent connecting rods may be within a range from 2.0 to 3.0 mm. In some embodiments, for each upper tooth of the patient, the connecting structure may include one or more connecting rods configured to connect a first portion of the retainer base corresponding to the upper tooth and a second portion of the teeth shell corresponding to the upper tooth. In some embodiments, for each upper tooth of the patient, a count of the one or more connecting rods may be the same. For example, as illustrated in FIGS. 4D and 4E, each upper tooth corresponds to one connecting rod. In some embodiments, for each upper tooth of the patient, the count of the one or more connecting rods may be different. For example, the connecting rods corresponding to the posterior teeth of the patient may be more closely spaced from each other than the connecting rods corresponding to the anterior teeth of the patient. That is, the count of connecting rods corresponding to one of the posterior teeth of the patient may be larger than the count of connecting rods corresponding to one of the anterior teeth of the patient.

In some embodiments, for each connecting rod, a shape of the connecting rod may be even. For example, the shape of the connecting rod may include a cylinder, a prism (e.g., a triangular prism, a quadrangular prism, etc.), or the like, or any combination thereof. In some embodiments, for each connecting rod, the shape of the connecting rod may be uneven. For example, for each connecting rod, the thickness (or diameter) of the connecting rod at an end connecting the teeth shell may be greater than the thickness (or diameter) of the connecting rod at an end connecting the retainer base. For instance, for each connecting rod, the thickness (or diameter) of the connecting rod may continuously increase along a direction from a first connection position between the connecting rod and the retainer base to a second connection position between the connecting rod and the teeth shell. In this way, the connecting rods can be easily removed from the retainer base with a simple snap, which can improve the efficiency of post-processing. As another example, at least a portion of the connecting rods may include a hollow structure. In some embodiments, a diameter (e.g., a maximum diameter, a minimum diameter, an average diameter, etc.) of each connecting rod may be within a certain range. For example, the diameter of each connecting rod may be within a range of 0.1 mm to 2.0 mm. As another example, the diameter of each connecting rod may be within a range of 0.2 mm to 1.0 mm. As still another example, the diameter of each connecting rod may be within a range of 0.5 mm to 0.8 mm.

By designing an uneven connecting rod, the thickness (or diameter) of each section can be adjusted. This not only meets the strength requirements for connecting the first portion of the retainer base to the second portion of the teeth shell corresponding to the upper tooth but also reduces the overall weight of the connecting rod, thereby conserving fabrication materials.

In some embodiments, the shapes of different connecting rods may be the same. For example, as illustrated in FIGS. 4D and 4E, each connecting rod is the cylinder. In some embodiments, the shapes of different connecting rods may be different. For example, the shape of a first portion of the connecting rods may be the cylinder, and the shape of a second portion of the connecting rods may be the quadrangular prism.

In some embodiments, the processing device 140 may determine the configuration of the connecting structure based on the second digital model and the third digital model. For example, for each upper tooth of the patient, the processing device 140 may determine the count of the one or more connecting rods corresponding to the upper tooth based on a first thickness of the retainer base corresponding to the upper tooth and a second thickness of the teeth shell corresponding to the upper tooth, and determine first connection positions between the one or more connecting rods and the retainer base and second connection positions between the one or more connecting rods and the teeth shell based on the first digital model, the second digital model, and the count of the one or more connecting rods. Further, the processing device 140 may create the fourth digital model based on the first digital model, the second digital model, and the first connection positions and the second connection positions of the one or more connecting rods corresponding to each upper tooth.

In order to ensure that the one or more connecting rods provide enough support for the retainer base and the teeth shell, the count of the one or more connecting rods corresponding to each upper tooth may be determined based on the first thickness of the retainer base corresponding to the upper tooth and the second thickness of the teeth shell corresponding to the upper tooth. Normally, more connecting rods are needed when the first thickness and the second thickness are large. For example, for each upper tooth, the processing device 140 may determine an average thickness of the first thickness and the second thickness, and determine the count of the one or more connecting rods based on the average thickness. Merely by way of example, the processing device 140 may determine a second corresponding relationship (e.g., a table, a graph, etc.) between reference counts of connecting rods and candidate thicknesses based on historical data. When the average thickness is obtained, the processing device 140 may retrieve the second corresponding relationship to determine the count of the one or more connecting rods based on the average thickness.

In some embodiments, the count of the one or more connecting rods corresponding to the upper tooth may be further determined based on the type and/or the size of the upper tooth. For example, the count of the one or more connecting rods corresponding to the posterior teeth of the patient may be greater than the count of the one or more connecting rods corresponding to the anterior teeth of the patient. As another example, the larger the size of the upper tooth is, the greater the count of the one or more connecting rods corresponding to the upper tooth may be.

Merely by way of example, the processing device 140 may determine a first initial count of the one or more connecting rods based on the first thickness and the second thickness corresponding to the upper tooth, determine a second initial count of the one or more connecting rods based on the type of the upper tooth, and determine a third initial count of the one or more connecting rods based on the size of the upper tooth. Then, the processing device 140 may designate a greatest initial count among the three initial counts as the count of the one or more connecting rods. Alternatively, the processing device 140 may determine the count of the one or more connecting rods by determining a weighted summation of the three initial counts.

A first connection position refers to the position of a connection point between one end of a connection rod and the retainer base, and a second connection position refers to the position of a connection point between the other end of the connection rod and the teeth shell. In some embodiments, for an upper tooth, the processing device 140 may determine the first connection positions and the second connection positions based on curvatures at different positions in the first portion of the retainer base corresponding to the upper tooth and curvatures at different positions in the second portion of the teeth shell corresponding to the upper tooth. Positions with low curvature are more suitable as connection positions, which can enhance the stability of the connecting rods. For example, if an upper tooth corresponds to A connecting rods (A being an integer greater than 0), the processing device 140 may determine B positions in the first portion with the minimum curvatures among different positions in the first portion, and determine B positions in the second portion with the minimum curvatures among different positions in the second portion, wherein B is an integer greater than A. Then, the processing device 140 may determine A pairs, each including one first connection position and one second connection position, from the B positions in the first portion and the B positions in the second portion such that the A connection rods can be arranged more evenly and uncrossed.

And then, the processing device 140 may create the fourth digital model based on the first digital model, the second digital model, and the first connection positions and the second connection positions of the one or more connecting rods corresponding to each upper tooth. For example, the processing device 140 may generate the first digital model by connecting the first digital model and the second digital model using digital models representing the one or more connecting rods corresponding to each upper tooth based on the first connection positions and the second connection positions of the one or more connecting rods.

In some embodiments, the processing device 140 may create the fourth digital model based on the second digital model and the third digital model through the processing software. For example, the processing device 140 may import the first connection positions and the second connection positions of the one or more connecting rods corresponding to each upper tooth into the processing software, and the processing software may create a digital model representing the one or more connecting rods corresponding to each upper tooth based on the first connection positions and the second connection positions of the one or more connecting rods to create the fourth digital model. Optionally, the processing device 140 may also import other parameters, such as the thickness of the connecting rod(s) into the processing software.

In 308, the processing device 140 (e.g., the generation module 230) may generate a printed assembly by printing the fourth digital model using a first curable resin material. The printed assembly may at least include the retainer base, the teeth shell, and the connecting structure.

A curable resin material refers to a polymer-based substance that undergoes a chemical reaction when exposed to specific conditions (e.g., heat, light, or a catalyst) to harden or cure into a solid form. Exemplary curable resin materials may include a thermosetting resin material, a photopolymer resin material, a chemically-cured resin material, or the like, or any combination thereof. The thermosetting resin material may permanently harden once the thermosetting resin material undergoes a curing process involving heat or chemical reactions. For example, the thermosetting resin material may include epoxy, polyester, polyurethane, or the like, or any combination thereof. The photopolymer resin material may cure when exposed to UV light. The chemically-cured resin material may cure when mixed with a chemical activator (e.g., hardeners or catalysts) that triggers a polymerization process.

In some embodiments, the curable resin material may include a dental clear aligner (DCA) material from LuxCreo, a dental night guard (DNG) resin from LuxCreo, a splint/nightguard resin, a denture base resin, a resin used in multi-material jetting or stereolithography (SLA) or selective laser sintering (SLS), or the like, or any combination thereof. Exemplary DCA materials may include thermoplastic polyurethane (TPU), polyethylene terephthalate glycol-modified (PET-G), or the like, or any combination thereof.

The first curable resin material refers to a curable resin material used to print the fourth digital model.

In some embodiments, the processing device 140 may direct a 3D printer (e.g., the 3D printer 110) to generate the printed assembly by printing the fourth digital model using the first curable resin material. At this time, the printed assembly may include the retainer base, the teeth shell, and the connecting structure.

By using the first curable resin material to generate the printed assembly, properties (e.g., mechanical properties, toughness properties, elasticity properties, etc.) of the retainer base generated based on the printed assembly can be improved. For example, the retainer base fabricated using the first curable resin material can have a thinner structure without risk of breakage compared to a retainer base fabricated using a traditional material (e.g., acrylic). In addition, since the elasticity properties of the retainer base are improved, the retainer base fabricated using the first curable resin material can be directly used as the orthodontic retainer, and no metal wire part needs to be assembled onto the retainer base for fixing, which can simplify the fabrication of the orthodontic retainer and reduce the manual labor for preparing the metal wire part and assembling the metal wire part onto the retainer base, thereby improving the efficiency of the orthodontic retainer fabrication.

In some embodiments, the processing device 140 may generate the printed assembly by integrally printing the fourth digital model.

In some embodiments, the processing device 140 may generate the printed assembly by printing multiple parts (or pieces) of the fourth digital model and assembling the multiple parts. For example, the processing device 140 may disassemble the fourth digital model into a plurality of sub-digital models, direct the 3D printer to generate multiple pieces corresponding to the plurality of sub-digital models, and generate the printed assembly by assembling the multiple pieces. In some embodiments, the multiple pieces may be assembled through a connection manner. Exemplary connection manners may include a wire connection, a glue connection, a weld connection, or the like, or any combination thereof. Merely by way of example, each of the multiple pieces may include one or more holes, and the multiple pieces may be connected by wires. By connecting the multiple pieces through the wires, gap distances between the multiple pieces can be increased, which can improve the flexibility of the retainer base, thereby improving user comfort. Furthermore, by printing the fourth digital model in multiple parts, the process difficulty for printing the retainer base can be reduced.

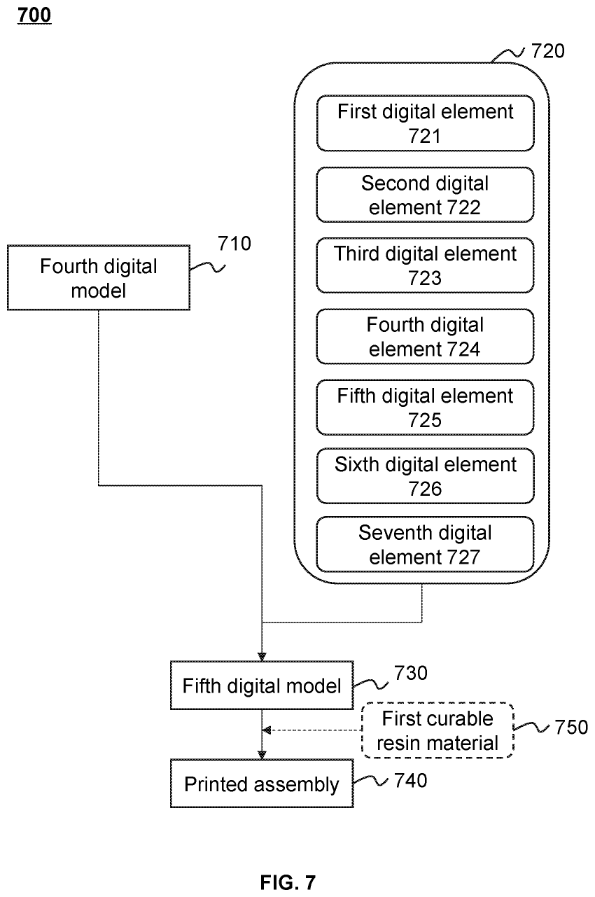

In some embodiments, the printed assembly may further include a functional structure. For example, the functional structure may include a wire guiding structure, a support structure, a connection structure, a surface structure, an internal structure, or the like, or any combination thereof. Merely by way of example, the processing device 140 may create a fifth digital model by adding at least one digital element to the fourth digital model, and generate the printed assembly by printing the fifth digital model using the first curable resin material. The at least one digital element may include at least one of a first digital element representing a wire guiding structure on the retainer base configured to place a metal wire part of the orthodontic retainer, a second digital element representing a support structure configured to support the teeth shell and the retainer base, a third digital element representing a connection structure on the retainer base configured to connect a screw expansion system, and a fourth digital element representing a surface structure and/or an internal structure for functional or aesthetic purposes. For example, as illustrated in FIG. 4F, the printed assembly includes a retainer base, a teeth shell, connection rods, and a support structure. More descriptions regarding the generation of the printed assembly may be found elsewhere in the present disclosure (e.g., FIGS. 7-9C and the descriptions thereof).

In some embodiments, the processing device 140 may generate a processed digital model by performing digital post-processing of the fourth digital model (or the fifth digital model), and direct the 3D printer (e.g., the 3D printer 110) to generate the printed assembly by printing the processed digital model using the first curable resin material. The digital post-processing may include trimming, polishing, smoothing, an anti-sensitive operation, or the like, or any combination thereof. Merely by way of example, the processing device 140 may post-process the fourth digital model (or the fifth digital model) using the processing software, such as LuxCreo's LuxDesign. For instance, the processing device 140 may digitally post-process the fourth digital model using Digital Polishing™ from LuxCreo. In this case, a portion of the post-processing (e.g., polishing the printed assembly) can be removed, which can simplify the fabrication process, thereby improving the efficiency of the retainer base fabrication.

In some embodiments, before printing the fourth digital model (or the fifth digital model, or the processed digital model), the processing device 140 may display the fourth digital model (or the fifth digital model, or the processed digital model) to a user (e.g., a doctor). For example, the fourth digital model may be displayed through a user interface of the at least one terminal 130, and the user may confirm and/or adjust the fourth digital model through an input device (e.g., a mouse, a keyboard, a touch screen, etc.) of the at least one terminal 130.

In 310, the printed assembly may be post-processed to obtain the retainer base.

The post-processing may include removing (e.g., trimming and/or buffing) residual resin material from a surface or internal structure of the printed assembly, washing the printed assembly, removing the teeth shell, removing the support structure, providing energy source to post-cure the printed assembly, polishing the printed assembly, or the like, or any combination thereof.

The operations in the post-processing may be performed in any suitable order. For example, when the printed assembly includes the support structure, the post-processing may include removing the teeth shell, the connecting structure, and the support structure from the printed assembly, and providing energy source to cure the printed assembly after the removal of the teeth shell, the connecting structure, and the support structure to obtain the retainer base. Alternatively, the post-processing may include providing energy source to post-cure the printed assembly, and removing the teeth shell, the connecting structure, and the support structure from the cured printed assembly to obtain the retainer base. Merely by way of example, after the printed assembly is generated, the printed assembly is first washed in iLuxWash Dental from LuxCreo, with two rounds of washing in isopropanol (IPA) of 4 minutes per round. The washed printed assembly is then baked in Septree oven at 90° C. for 1 hour. Further, the printed assembly is post-cured in iLuxCure Pro with a DCA setting (30 minutes with 100% power) to obtain the final retainer base.

In some embodiments, the process 300 may further include a wire assembly step to assemble a metal wire part onto the retainer base to obtain the orthodontic retainer. For example, when the printed assembly further includes the wire guiding structure, the metal wire part may be assembled onto the retainer base via the wire guiding structure, the metal wire part may be secured to the retainer base using a second curable resin material, and an energy source may be provided to cure the second curable resin material, and the retainer base assembled with the metal wire part may be trimmed and/or buffed to obtain the orthodontic retainer.

The second curable resin material refers to a curable resin material configured to secure the metal wire part to the retainer base. In some embodiments, the second curable resin material may be the same as the first curable resin material. For example, the second curable resin material and the first curable resin material may both be the DCA material. In some embodiments, the second curable resin material may be different from the first curable resin material. For example, the first curable resin material may be the DCA material, and the second curable resin material may include a powder polymer and a liquid monomer. The powder polymer and the liquid monomer may correspond to different states of a same material, such as, polymethyl methacrylate. Merely by way of example, the powder polymer may be first applied to flow underneath the metal wire part, and then the liquid polymer may be applied over the metal wire part. The operation may be repeated over until there is a 2.5-3 mm buildup of the second curable resin material. Further, the metal wire part may be secured to the retainer base through the 2.5-3 mm buildup of the second curable resin material.

In some embodiments, if the printed assembly includes the wire guiding structure, the retainer base assembled with the metal wire part may be determined as the orthodontic retainer (e.g., the final product). If the printed assembly includes no wire guiding structure, the retainer base may be determined as the orthodontic retainer.

In some embodiments, the orthodontic retainer may include another metal part other than the metal wire part, such as, the screw expansion system for palatal expander. The screw expansion system may be assembled onto the retainer base in a similar manner as how the metal wire part is assembled onto the retainer base.

According to some embodiments of the present disclosure, by printing the fourth digital model using the first curable resin material, the printed assembly can be generated directly, which can reduce or eliminate the manual labor, and thereby improving the efficiency and accuracy of the orthodontic retainer fabrication. In addition, by using the first curable resin material, the properties of the retainer base can be improved, so that a thickness and/or a weight of the retainer base are reduced, thereby improving the user experience. In some embodiments, no metal wire part needs to be assembled onto the retainer base for fixing, which can simplify the fabrication of the orthodontic retainer and further reduce the manual labor, thereby improving the efficiency of the orthodontic retainer fabrication.

FIG. 5 is a flowchart illustrating an exemplary process 500 for creating a second digital model representing a retainer base according to some embodiments of the present disclosure. In some embodiments, the process 500 may be performed to achieve at least part of operation 304 as described in connection with FIG. 3.

In 502, the processing device 140 (e.g., the creation module 220) may determine a relapse probability of each upper tooth based on tooth characteristics of the upper tooth.

A relapse probability of an upper tooth refers to a probability of the upper tooth shifting back toward its original position (or its pre-treatment position) from its adjusted/orthodontic position. In some embodiments, the relapse probability of the upper tooth may relate to the tooth characteristics of the upper tooth.

The tooth characteristics may at least include one or more characteristics relating to a correction path of the upper tooth. For example, the characteristic(s) relating to the correction path of the upper tooth may include a length of the correction path and/or an angle of the correction path with respect to a reference direction. The reference direction may be any direction, for example, a direction facing occlusal surfaces of the teeth or a direction away from the occlusal surfaces of the teeth.

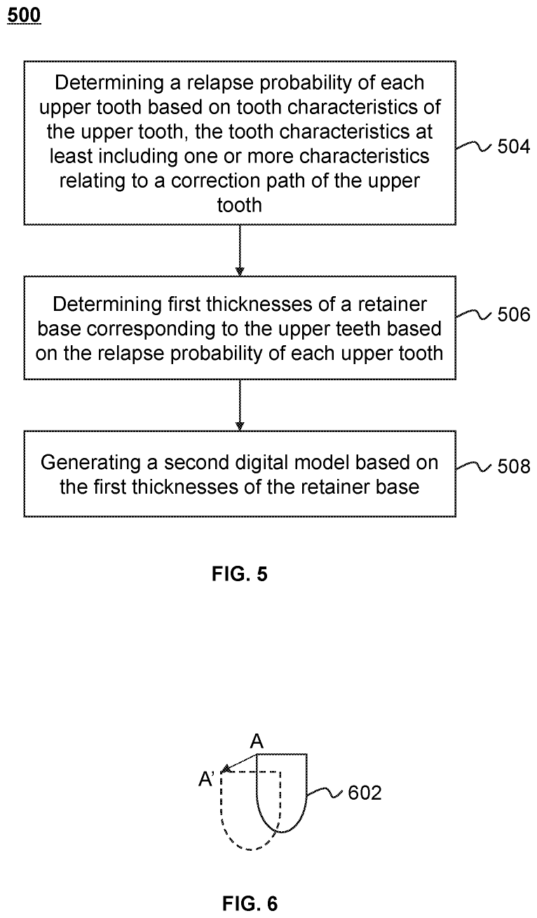

The correction path of the upper tooth refers to a movement path of the upper tooth during orthodontic treatment. In some embodiments, the correction path of the upper tooth may be represented as a connecting line between an original position of a feature point of the upper tooth and an orthodontic position of the feature point. Exemplary feature points of the upper tooth may include a central point, a corner point, or the like, or any combination thereof. For example, referring to FIG. 6, FIG. 6 is a schematic diagram illustrating an exemplary correction path of an upper tooth 602 according to some embodiments of the present disclosure. As illustrated in FIG. 6, during the orthodontic treatment, a feature point at a top-left corner of the upper tooth 602 moves from an original position A to an orthodontic position A′, and a corresponding correction path of the upper tooth 602 is indicated by an arrow AA′.

In some embodiments, the correction path may be represented by a vector. In some embodiments, the correction path may be represented by parameters such as the length of the correction path, the angle of the correction path with respect to the reference direction, locations of points along the correction path, or the like, or any combination thereof.

In some embodiments, the relapse probability of the upper tooth may be positively related to the characteristic(s) relating to the correction path of the upper tooth. For example, the longer the length of the correction path is, the greater the relapse probability of the upper tooth may be. As another example, the larger the angle of the correction path with respect to the reference direction is, the greater the relapse probability of the upper tooth may be.

In some embodiments, the tooth characteristics of the upper tooth may further include a correction angle of the upper tooth, the type of the upper tooth, the size of the upper tooth, or the like, or any combination thereof. The correction angle of the upper tooth refers to an angle difference of the upper tooth between before and after the orthodontic treatment. For example, the correction angle of the upper tooth may be an angle difference in an enamel surface of the upper tooth before and after the orthodontic treatment. In some embodiments, the relapse probability of the upper tooth may be positively related to the characteristic(s) relating to the correction path of the upper tooth. For example, the larger the correction angle of the upper tooth is, the greater the relapse probability of the upper tooth may be.

The type of the upper tooth may include the posterior teeth and the anterior teeth. For example, a relapse probability of a posterior tooth may be greater than a relapse probability of an anterior tooth.

In some embodiments, the relapse probability of the upper tooth may be positively related to the size of the upper tooth. For example, the larger the size of the upper tooth is, the greater the relapse probability of the upper tooth may be.

In some embodiments, the relapse probability of the upper tooth may be further determined based on tooth characteristics of each adjacent upper tooth of the upper tooth. Since there is extrusion between the adjacent teeth, the tooth characteristics of each adjacent upper tooth of the upper tooth may also affect the relapse probability of the upper tooth. For example, an initial relapse probability of each upper tooth may be determined based on its tooth characteristics. For a certain upper tooth, and the relapse probability of the upper tooth may be determined based on its initial relapse probability and the relapse probability of its adjacent upper tooth. Merely by way of example, the relapse probability of the upper tooth may be determined by adding an adjustment amount to its initial relapse probability if the relapse probability of its adjacent upper tooth exceeds a threshold.

The impact of an adjacent upper tooth to the upper tooth may relate to a gap size between the upper tooth and the adjacent upper tooth and/or a contact area between the upper tooth and the adjacent upper tooth. The larger the gap size between the upper tooth and the adjacent upper tooth is, the smaller the impact of the adjacent upper tooth to the upper tooth may be. The larger the contact area between the upper tooth and the adjacent upper tooth is, the greater the impact of the adjacent upper tooth on the upper tooth may be. In some embodiments, the processing device 140 may determine an impact factor of each adjacent upper tooth based on the gap size between the upper tooth and the adjacent upper tooth and/or the contact area between the upper tooth and the adjacent upper tooth, and determine the relapse probability based on the tooth characteristics of the upper tooth, the tooth characteristics of each adjacent upper tooth of the upper tooth, and the impact factor of each adjacent upper tooth of the upper tooth. For example, for each adjacent upper tooth, an adjustment amount may be determined based on the initial relapse probability and the impact factor of the adjacent upper tooth. The relapse probability of the upper tooth may be determined by adding the adjustment amount of each adjacent upper tooth to the initial relapse probability of the upper tooth.

In some embodiments, the processing device 140 may determine the relapse probability of the upper tooth using a relapse probability determination model. For example, the processing device 140 may input the tooth characteristics of the upper tooth (and the tooth characteristics of each adjacent upper tooth of the upper tooth) into the relapse probability determination model, and the relapse probability determination model may output the relapse probability of the upper tooth.

The relapse probability determination model refers to a model used to determine the relapse probability of the upper tooth. In some embodiments, the relapse probability determination model may be a trained machine learning model, such as, a neural network model, which is not limited to herein.

In some embodiments, the relapse probability determination model may be generated through a training process. For example, the processing device 140 may obtain a plurality of training samples. Each of the plurality of training samples may include sample tooth characteristics of a sample upper tooth (and sample tooth characteristics of each sample adjacent upper tooth of the sample upper tooth) and a gold standard relapse probability of the sample upper tooth. The processing device 140 may generate the relapse probability determination model by training an initial model using the plurality of training samples.

In some embodiments, an input of the relapse probability determination model may further include a first digital model corresponding to the upper tooth. For example, the processing device 140 may input the tooth characteristics of the upper tooth (and the tooth characteristics of each adjacent upper tooth of the upper tooth) and the first digital model corresponding to the upper teeth into the relapse probability determination model, and the relapse probability determination model may output the relapse probability of the upper tooth. By inputting the first digital model together with the tooth characteristics of the upper tooth, more information can be provided to determine the relapse probability of the upper tooth, which can improve the accuracy of the determination of the relapse probability.

In 504, the processing device 140 (e.g., the creation module 220) may determine first thicknesses of a retainer base corresponding to the upper teeth based on the relapse probability of each upper tooth.

The first thickness of the retainer base corresponding to an upper tooth may be positively correlated with the relapse probability of the upper tooth. That is, the larger the relapse probability of the upper tooth is, the greater the first thickness corresponding to the upper tooth may be.

In some embodiments, the processing device 140 may determine a third corresponding relationship between reference first thicknesses of the retainer base and reference relapse probabilities of the upper teeth, and determine the first thicknesses of the retainer base corresponding to the upper teeth based on the relapse probability of each upper tooth and the third corresponding relationship. Merely by way of example, the processing device 140 may create a table, a graph, etc., indicating the third corresponding relationship based on historical data. When the relapse probability of each upper tooth is obtained, the processing device 140 may retrieve the table, the graph, etc., to determine the first thicknesses of the retainer base corresponding to the upper teeth based on the relapse probability of each upper tooth.

In some embodiments, a difference between the relapse probabilities of adjacent upper teeth may be relatively large, and a difference between the first thicknesses of the retainer base corresponding to the adjacent upper teeth may be relatively large, which reduces the user experience. Therefore, for each upper tooth, the processing device 140 may determine an initial first thickness of the retainer base corresponding to the upper tooth based on the relapse probability of the upper tooth, and determine the first thicknesses of the retainer base by correcting the initial first thicknesses of the retainer base corresponding to the upper teeth based on a distribution of the initial first thicknesses along an arrangement direction of the upper teeth. For example, the processing device 140 may determine a thickness difference threshold between adjacent teeth, and correct the initial first thicknesses of the retainer base based on the thickness difference threshold to determine the first thicknesses of the retainer base. The thickness difference threshold refers to a maximum thickness difference between the first thicknesses of two adjacent teeth. In some embodiments, the thickness difference threshold may be determined according to user preference. For example, the thickness difference threshold may be determined for each patient. Merely by way of example, if a thickness difference between the first thicknesses of two adjacent teeth is larger than the thickness difference threshold, the processing device 140 may enhance the smaller first thickness to satisfy the thickness difference threshold.

As another example, the processing device 140 may smooth the initial first thicknesses of the retainer base corresponding to the upper teeth based on the distribution of the initial first thicknesses along the arrangement direction of the upper teeth. For instance, the processing device 140 may use a fitting algorithm to process the initial first thicknesses of the retainer base corresponding to the upper teeth based on the distribution of the initial first thicknesses along the arrangement direction of the upper teeth.

By correcting the initial first thicknesses of the retainer base, the thickness of the retainer base changes smoothly along the arrangement direction of the upper teeth, so that the wearing experience of the retainer base can be improved.

In 506, the processing device 140 (e.g., the creation module 220) may generate a second digital model based on the first thicknesses of the retainer base.

For example, the processing device 140 may determine a shape of the second digital model by fitting the palate in the first digital model, and create the second digital model based on the shape of the second digital model and the first thicknesses of the retainer base.

According to some embodiments of the present disclosure, the first thicknesses of the retainer base corresponding to the upper teeth can be determined based on the relapse probability of each upper tooth, which can prevent the relapse and improve the orthodontic effectiveness.

FIG. 7 is a schematic diagram illustrating an exemplary process 700 for generating a printed assembly according to some embodiments of the present disclosure. In some embodiments, the process 700 may be performed to achieve at least part of operation 308 as described in connection with FIG. 3.

As illustrated in FIG. 7, a fifth digital model 730 may be created by adding at least one digital element 720 to a fourth digital model 710. The at least one digital element 720 may include a first digital element 721 representing a wire guiding structure on a retainer base configured to place a metal wire part of an orthodontic retainer, a second digital element 722 representing a support structure configured to support a teeth shell and the retainer base, a third digital element 723 representing a connection structure on the retainer base configured to connect a screw expansion system, a fourth digital element 724 representing a surface structure and/or an internal structure for functional or aesthetic purposes, a fifth digital element 725 representing an extended base configured to place the printed assembly, a sixth digital element 726 representing an anchor support or an increased retention configured to encapsulate one or more teeth (e.g., the molars or bicuspids of the maxillar), a seventh digital element 727 representing a pontic bridge configured to hold a gap between two teeth, etc. And then, a printed assembly 740 may be generated by printing the fifth digital model 730 using a first curable resin material 750.

In some embodiments, the processing device 140 may create the fifth digital model 730 using the processing software, such as LuxCreo's LuxDesign.

For illustration purposes, four examples of generating the printed assembly are provided below.

### Example 1

The fifth digital model 730 may be created by adding the first digital element 721 representing the wire guiding structure on the retainer base configured to place the metal wire part of the orthodontic retainer, and the printed assembly 740 may be generated by printing the fifth digital model 730 using the first curable resin material 750. The printed assembly 740 may further include the wire guiding structure. In some embodiments, the wire guiding structure may include channels or grooves for placing the metal wire part.

### Example 2

The fifth digital model 730 may be created by adding the second digital element 722 representing the support structure configured to support the teeth shell and the retainer base, and the printed assembly 740 may be generated by printing the fifth digital model 730 using the first curable resin material 750. The printed assembly 740 may further include the support structure.

The support structure may include any structure that can provide structural support for the teeth shell and the retainer base. For example, the support structure includes supporting columns, supporting platform, or the like, or any combination thereof. In some embodiments, the support structure may be connected to the teeth shell.

In some embodiments, the retainer base and the tooth shell are oriented vertically or with a pre-designed degree with respect to the support structure. For example, the angle between the support structure and the retainer base/teeth shell may be an angle between a vertical direction of the support structure and a symmetry axis of the retainer base/teeth shell (or a bottom surface of the teeth shell). For example, the angle between the support structure and the retainer base/teeth shell may be within a range of 0 degrees to 90 degrees. As another example, the angle between the support structure and the retainer base/teeth shell may be within a range of 30 degrees to 90 degrees. As still another example, the angle between the support structure and the retainer base/teeth shell may be within a range of 45 degrees to 90 degrees. As yet another example, the angle between the support structure and the retainer base/teeth shell may be within a range of 45 degrees to 75 degrees.

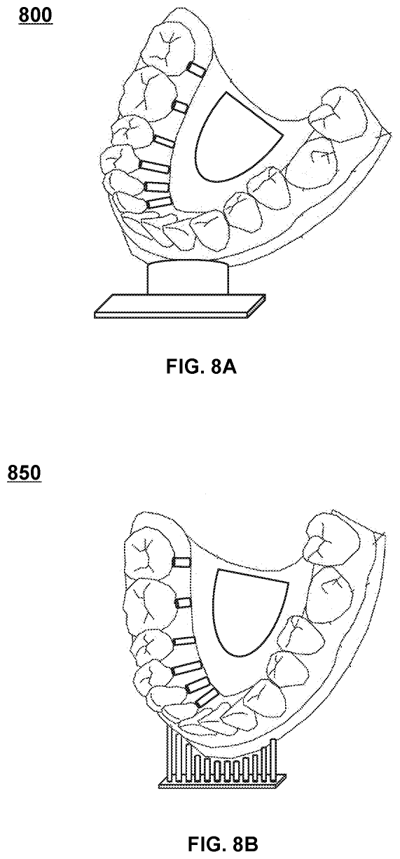

Merely by way of example, referring to FIGS. 8A and 8B, FIGS. 8A and 8B are schematic diagram illustrating exemplary fifth digital models including second digital element representing support structures according to some embodiments of the present disclosure. As illustrated in FIG. 8A, an angle between a support structure and a retainer base/teeth shell is 45 degrees. As illustrated in FIG. 8B, an angle between a support structure and a retainer base/teeth shell is 90 degrees.

Since the support structure is configured to support the teeth shell and the retainer base, the processing device 140 may determine a configuration of the support structure based on the second digital model and the third digital model. The configuration of the support structure may include a shape of the support structure, a support position of the support structure, a contact area between the support structure and the retainer base/teeth shell, an angle between the support structure and the retainer base/teeth shell, or the like, or any combination thereof. For example, the processing device 140 may determine first structural information of the retainer base based on the second digital model, and determine second structural information of the teeth shell based on the third digital model. Further, the processing device 140 may determine the configuration of the support structure based on the first structural information and the second structural information.

The structural information may include thickness information, shape information, weight information, or the like, or any combination thereof. Merely by way of example, the first structural information may include first weight information of the retainer base, and the second structural information may include second weight information of the teeth shell. The first weight information may include an estimated weight and/or a weight distribution of the retainer base, and the second weight information may include an estimated weight and/or a weight distribution of the teeth shell. For example, the support position of the support structure may be set at positions with heavier weight; a greater contact area may be set if the retainer base and the teeth shell have a heavier weight; and the angle may be set to be close to 180 degrees if the retainer base and the teeth shell have a heavier weight.

As another example, the first weight information may be determined based on first thicknesses of the retainer base, and the second weight information may be determined based on second thicknesses of the teeth shell. Merely by way of example, the estimated weight of the retainer base may be positively related to the first thicknesses of the retainer base, and the estimated weight of the teeth shell may be positively related to the second thicknesses of the teeth shell. For example, the support position of the support structure may be set at positions with thicker thickness; a greater contact area may be set if the retainer base and the teeth shell have a thicker thickness; and the angle may be set to be close to 180 degrees if the retainer base and the teeth shell have a thicker thickness.

### Example 3

The fifth digital model 730 may be created by adding the third digital element 723 representing the connection structure on the retainer base configured to connect the screw expansion system, and the printed assembly 740 may be generated by printing the fifth digital model 730 using the first curable resin material 750. The printed assembly 740 may further include the connection structure. In some embodiments, the connection structure may include a channel or a hole for connecting (e.g., fixing) the screw expansion system. The screw expansion system may be used for palatal expander. For example, the screw expansion system may be used to widen the palate (or the upper jaw) to correct dental crowding, crossbites, or improve breathing by increasing the space in the oral chamber.

### Example 4

The fifth digital model 730 may be created by adding the fourth digital element 724 representing the surface structure and/or the internal structure for functional or aesthetic purposes, and the printed assembly 740 may be generated by printing the fifth digital model 730 using the first curable resin material 750. The printed assembly 740 may further include the surface structure and/or the internal structure. For example, the surface structure and/or the internal structure may include a pocket, a channel, an indentation, or the like, or any combination thereof. The pocket, the channel, or the indentation may be any color, shape, pattern, size, count, etc. For instance, the processing device 140 may add patterned channels that can be filled with color inks on the fourth digital model 710 to create the fifth digital model 730. As another example, the processing device 140 may add an indentation in the center of the fourth digital model 710 (even throughout the entire fourth digital model 710) to the fifth digital model 730. By inserting custom colors/dyes/pigments into the indentation, pre-programmed patterns may be created, allowing for generatively designed and automatically fabricated bespoke color and pattern designs on the surface of the retainer base. For example, colored UV or heat curable resin may be injected into the surface structure and/or the internal structure, and be cured to achieve the aesthetic purpose.

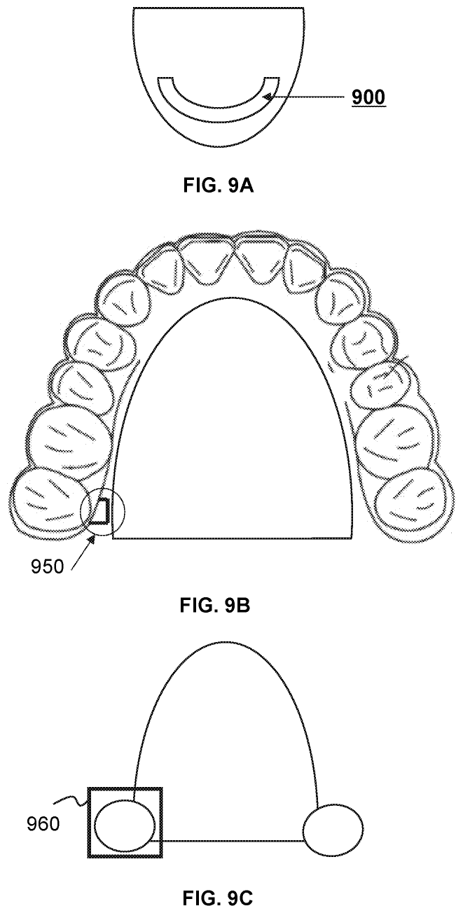

Merely by way of example, referring to FIG. 9A, FIG. 9A is a schematic diagram illustrating an exemplary fifth digital model including a fourth digital element representing an internal structure according to some embodiments of the present disclosure. As illustrated in FIG. 9A, the internal structure is a channel 900.

### Example 5

The fifth digital model 730 may be created by adding the fifth digital element 725 representing the extended base configured to place the printed assembly, and the printed assembly 740 may be generated by printing the fifth digital model 730 using the first curable resin material 750. The printed assembly 740 may further include the extended base.

Merely by way of example, referring to FIG. 9B, FIG. 9B is a schematic diagram illustrating an exemplary fifth digital model including a fifth digital element representing an extended base according to some embodiments of the present disclosure. As illustrated in FIG. 9B, an extended base 950 is located at the inner side of the teeth shell. In this fashion, once the retainer base is printed, the printed parts can be placed on the operation surface on the extended base, which allows for better handling ergonomics.

In some embodiments, a length of the extended base may be at a centimeter level. For example, the length of the extended base may be within a range from 1 centimeter (cm) to 10 cm. As another example, the length of the extended base may be within a range from 2 cm to 8 cm. As still another example, the length of the extended base may be within a range from 3 cm to 7 cm. As yet another example, the length of the extended base may be within a range from 4 cm to 6 cm. As yet another example, the length of the extended base may be 5 cm.

### Example 6

The fifth digital model 730 may be created by adding the sixth digital element 726 representing the anchor support or the increased retention configured to encapsulate the one or more teeth, and the printed assembly 740 may be generated by printing the fifth digital model 730 using the first curable resin material 750. The printed assembly 740 may further include the anchor support or the increased retention.

Merely by way of example, referring to FIG. 9C, FIG. 9C is a schematic diagram illustrating an exemplary fifth digital model including a sixth digital element representing an anchor support according to some embodiments of the present disclosure. As illustrated in FIG. 9C, an anchor support 960 is located at two sides of the retainer base. In this fashion, once the retainer base is printed, the anchor support can cover the molars or bicuspids of the maxillar, which can assist in securing the placement of the retainer base.

### Example 7

The fifth digital model 730 may be created by adding the seventh digital element 727 representing the pontic bridge configured to hold the gap between two teeth constant while performing other orthodontic work (i.e. Palatal expansion/retention), and the printed assembly 740 may be generated by printing the fifth digital model 730 using the first curable resin material 750. The printed assembly 740 may further include the pontic bridge.

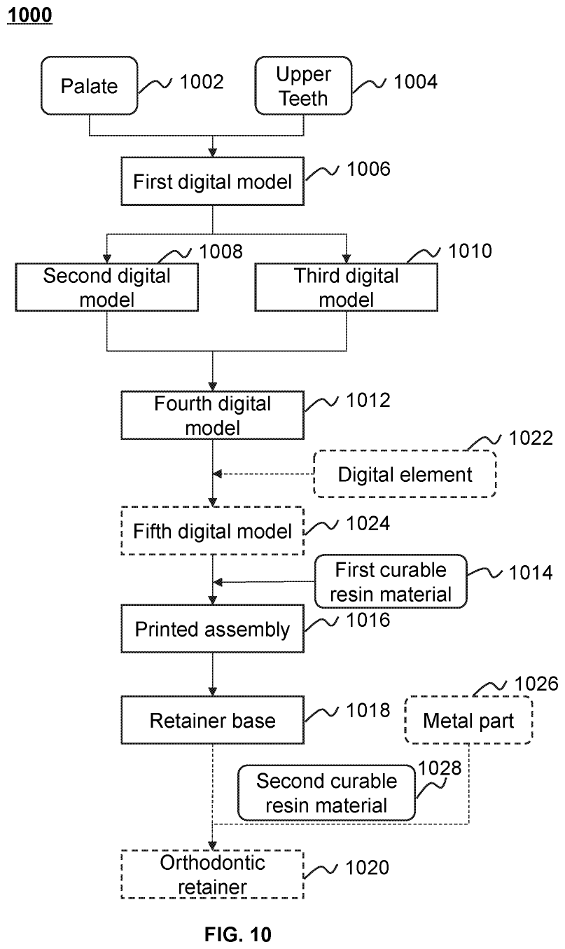

FIG. 10 is a schematic diagram illustrating an exemplary process 1000 for fabricating an orthodontic retainer 1020 according to some embodiments of the present disclosure.

As shown in FIG. 10, a first digital model 1006 representing the palate 1002 and the upper teeth 1004 of a patient may be obtained by scanning the palate 1002 and the upper teeth 1004 of the patient. A second digital model 1008 representing a retainer base 1018 and a third digital model 1010 representing a teeth shell may be created based on the first digital model 1006. A fourth digital model 1012 representing the retainer base 1018 and the teeth shell that are connected via a connecting structure may be created based on the second digital model 1008 and the third digital model 1010. A printed assembly 1016 may be generated by printing the fourth digital model 1012 using a first curable resin material 1014. The printed assembly may include the retainer base 1018, the teeth shell, and the connecting structure. Further, the retainer base 1018 may be obtained by post-processing the printed assembly 1016.

In some embodiments, the orthodontic retainer 1020 may further include a functional structure. A fifth digital model 1024 may be created by adding at least one digital element 1022 (e.g., a first digital element representing a wire guiding structure on the retainer base 1018 configured to place a metal wire part of the orthodontic retainer 1020) to the fourth digital model 1012, and the printed assembly 1016 may be generated by printing the fifth digital model 1024 using the first curable resin material 1014.

In some embodiments, the orthodontic retainer 1020 may include no metal part 1026 (e.g., the metal wire part), and the retainer base 1018 may be designated as the orthodontic retainer 1020.

In some embodiments, the orthodontic retainer 1020 may further include a metal part 1026 (e.g., the metal wire part). The metal part 1026 may be assembled onto the retainer base 1018 via a metal guiding structure (e.g., the wire guiding structure) using a second curable resin material 1028. The orthodontic retainer 1020 may be obtained by post-processing the retainer base 1018 assembling with the metal part 1026.

At least a portion of processes 300, 500, 700, and 1000 may be implemented in the system 100 illustrated in FIG. 1. For example, at least a portion of the processes 300, 500, 700, and 1000 may be stored in the storage device 150 as a form of instructions, and invoked and/or executed by the processing device 140. The operations of the illustrated process presented below are intended to be illustrative. In some embodiments, the processes 300, 500, 700, and 1000 may be accomplished with one or more additional operations not described, and/or without one or more of the operations discussed. Additionally, the order in which the operations of the processes 300, 500, 700, and 1000 are not intended to be limiting.

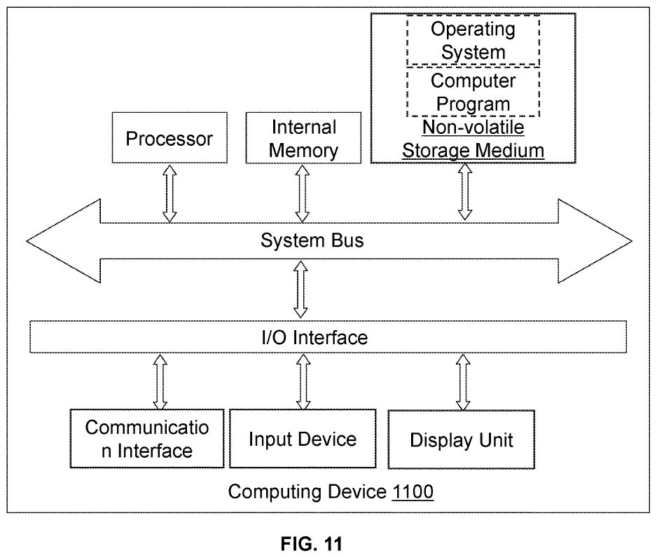

FIG. 11 is a schematic diagram illustrating an exemplary computing device 1100 according to some embodiments of the present disclosure.

In some embodiments, one or more components of the system 100 may be implemented on the computing device 1100. For example, the processing device 140 may be implemented on the computing device 1100 and configured to implement the functions and/or methods disclosed in the present disclosure.

The computing device 1100 may include any components used to implement the system 100 described in the present disclosure. For example, the processing device 140 may be implemented through hardware, software program, firmware, or any combination thereof, on the computing device 1100. For illustration purposes, only one computer is described in FIG. 11, but computing functions related to the system 100 described in the present disclosure may be implemented in a distributed fashion by a group of similar platforms to spread the processing load of the system 100.

The computing device 1100 may include a communication port connected to a network to achieve data communication. The computing device 1100 may include a processor (e.g., a central processing unit (CPU)), a memory, a communication interface, a display unit, and an input device connected by a system bus. The processor of the computing device 1100 may be used to provide computing and control capabilities. The memory of the computing device 1100 may include a non-volatile storage medium, an internal memory. The non-volatile storage medium may store an operating system and a computer program. The internal memory may provide an environment for the execution of the operating system and the computer program in the non-volatile storage medium. The communication interface of the computing device 1100 may be used for wired or wireless communication with an external terminal. The wireless communication may be realized through Wi-Fi, a mobile cellular network, a near field communication (NFC), etc. When the computer program is executed by the processor, a method for determining feature points may be implemented. The display unit of the computing device 1100 may include a liquid crystal display screen or an electronic ink display screen. The input device of the computing device 1100 may include a touch layer covered on the display unit, a device (e.g., a button, a trackball, a touchpad, etc.) set on the housing of the computing device 1100, an external keyboard, an external trackpad, an external mouse, etc.

Merely for illustration, only one processor is described in FIG. 11. However, it should be noted that the computing device 1100 in the present disclosure may also include multiple processors. Thus operations and/or method steps that are performed by one processor as described in the present disclosure may also be jointly or separately performed by the multiple processors. For example, if the processor of the computing device 1100 in the present disclosure executes both operation A and operation B, it should be understood that operation A and operation B may also be performed by two or more different processors jointly or separately (e.g., a first processor executes operation A and a second processor executes operation B, or the first and second processors jointly execute operations A and B).

Some embodiments of the present disclosure also provide a computer-readable storage medium. The computer-readable storage medium may store computer-executable instructions, and the computer-executable instructions may be used to cause a computer to implement the processes in the above embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for fabricating an orthodontic retainer comprising a retainer base, the method comprising:
obtaining a first digital model representing the palate and the upper teeth of a patient;
creating, based on the first digital model, a second digital model representing the retainer base and a third digital model representing a teeth shell;
creating, based on the second digital model and the third digital model, a fourth digital model representing the retainer base and the teeth shell that are connected via a connecting structure;
generating a printed assembly by printing the fourth digital model using a first curable resin material, the printed assembly at least including the retainer base, the teeth shell, and the connecting structure; and
post-processing the printed assembly to obtain the retainer base.

2. The method of claim 1, wherein the generating a printed assembly by printing the fourth digital model using a first curable resin material further comprises:
creating a fifth digital model by adding at least one digital element to the fourth digital model, the at least one digital element includes a first digital element representing a wire guiding structure on the retainer base configured to place a metal wire part of the orthodontic retainer; and
generating the printed assembly by printing the fifth digital model using the first curable resin material, the printed assembly further including the wire guiding structure.

3. The method of claim 2, further comprising:
assembling the metal wire part onto the retainer base via the wire guiding structure;
securing the metal wire part to the retainer base using a second curable resin material;
providing energy source to cure the second curable resin material; and
trimming or buffing the retainer base assembled with the metal wire part to obtain the orthodontic retainer.

4. The method of claim 1, wherein the generating a printed assembly by printing the fourth digital model using a first curable resin material further comprises:
creating a fifth digital model by adding at least one digital element to the fourth digital model, the at least one digital element includes a second digital element representing a support structure configured to support the teeth shell and the retainer base; and
generating the printed assembly by printing the fifth digital model using the first curable resin material, the printed assembly further including the support structure.

5. The method of claim 4, wherein the post-processing the printed assembly to obtain the retainer base comprises:
removing the teeth shell, the connecting structure, and the support structure from the printed assembly; and
providing energy source to post-cure the printed assembly after the removal of the teeth shell, the connecting structure, and the support structure to obtain the retainer base.

6. The method of claim 4, wherein the post-processing the printed assembly to obtain the retainer base comprises:
providing energy source to post-cure the printed assembly; and
removing the teeth shell, the connecting structure, and the support structure from the cured printed assembly to obtain the retainer base.

7. The method of claim 4, wherein the second digital element representing the support structure is added to the fourth digital model by:
determining first structural information of the retainer base based on the second digital model;
determining second structural information of the teeth shell based on the third digital model; and
determining a configuration of the support structure based on the first structural information and the second structural information.

8. The method of claim 7, wherein the first structural information includes first weight information, the second structural information includes second weight information, the first weight information and the second weight information include a t least one o f an estimated weight or a weight distribution,
the configuration of the support structure includes a support position of the support structure, a contact area between the support structure and the retainer base/teeth shell, an angle between the support structure and the retainer base/teeth shell.

9. The method of claim 1, wherein the generating a printed assembly by printing the fourth digital model using a first curable resin material further comprises:
creating a fifth digital model by adding at least one digital element to the fourth digital model, the at least one digital element includes a third digital element representing a connection structure on the retainer base configured to connect a screw expansion system; and
generating the printed assembly by printing the fifth digital model using the first curable resin material, the printed assembly further including the connection structure.

10. The method of claim 2, wherein the at least one digital element further includes a t least one o f a fourth digital element representing a surface structure or an internal structure for functional or aesthetic purposes.

11. The method of claim 1, wherein the second digital model representing the retainer base is created by:
determining a relapse probability of each upper tooth based on tooth characteristics of the upper tooth, the tooth characteristics at least including one or more characteristics relating to a correction path of the upper tooth;
determining first thicknesses of the retainer base corresponding to the upper teeth based on the relapse probability of each upper tooth; and
generating the second digital model based on the first thicknesses of the retainer base.

12-17. (canceled)

18. The method of claim 1, wherein the third digital model representing the teeth shell is created by:
creating an initial digital model representing a surrounding teeth part based on the first digital model; and
creating the third digital model representing the teeth shell by hollowing the initial digital model.

19. The method of claim 18, wherein the creating the third digital model by hollowing the initial digital model comprises:
determining second thicknesses of the teeth shell corresponding to the upper teeth based on first thicknesses of the retainer base corresponding to the upper teeth; and
creating the third digital model by hollowing the initial digital model based on the second thicknesses of the teeth shell.

20. The method of claim 19, wherein the determining second thicknesses of the teeth shell corresponding to the upper teeth based on first thicknesses of the retainer base corresponding to the upper teeth comprises:
determining initial second thicknesses of the teeth shell based the first thicknesses of the retainer base corresponding to the upper teeth; and
normalizing the initial second thicknesses of the teeth shell into a reference range to determine the second thicknesses.

21. The method of claim 1, wherein for each upper tooth of the patient, the connecting structure includes one or more connecting rods configured to connect a first portion of the retainer base corresponding to the upper tooth and a second portion of the teeth shell corresponding to the upper tooth,
the connecting rods corresponding to the posterior teeth of the patient are more closely spaced from each other than the connecting rods corresponding to the anterior teeth of the patient.

22. The method of claim 21, wherein the creating a fourth digital model comprises:
for each upper tooth of the patient,
determining the count of the one or more connecting rods corresponding to the upper tooth based on a first thickness of the retainer base corresponding to the upper tooth and a second thickness of the teeth shell corresponding to the upper tooth;
determining first connection positions between the one or more connecting rods and the retainer base and second connection positions between the one or more connecting rods and the teeth shell based on the first digital model, the second digital model, and the count of the one or more connecting rods; and
creating the fourth digital model based on the first digital model, the second digital model, and the first connection positions and the second connection positions of the one or more connecting rods corresponding to each upper tooth.

23. (canceled)

24. The method of claim 22, wherein
the first connection positions and the second connection positions are determined based on curvatures at different positions in the first portion and curvatures at different positions in the second portion.

25. The method of claim 1, wherein the connecting structure includes connecting rods configured to connect the retainer base and the teeth shell,
for each connecting rod, the thickness of the connecting rod at an end connecting the teeth shell is greater than the thickness of the connecting rod at an end connecting the retainer base.

26. A system for fabricating an orthodontic retainer comprising a retainer base, comprising:
at least one storage device including a set of instructions; and
at least one processor configured to communicate with the at least one storage device, wherein when executing the set of instructions, the at least one processor is configured to direct the system to perform operations including:
obtaining a first digital model representing the palate and the upper teeth of a patient;
creating, based on the first digital model, a second digital model representing the retainer base and a third digital model representing a teeth shell;
creating, based on the second digital model and the third digital model, a fourth digital model representing the retainer base and the teeth shell that are connected via a connecting structure;
generating a printed assembly by printing the fourth digital model using a first curable resin material, the printed assembly at least including the retainer base, the teeth shell, and the connecting structure; and
post-processing the printed assembly to obtain the retainer base.

27. A non-transitory computer readable medium, comprising executable instructions that, when executed by at least one processor, direct the at least one processor to perform a method for fabricating an orthodontic retainer comprising a retainer base, the method comprising:
obtaining a first digital model representing the palate and the upper teeth of a patient;
creating, based on the first digital model, a second digital model representing the retainer base and a third digital model representing a teeth shell;
creating, based on the second digital model and the third digital model, a fourth digital model representing the retainer base and the teeth shell that are connected via a connecting structure;
generating a printed assembly by printing the fourth digital model using a first curable resin material, the printed assembly at least including the retainer base, the teeth shell, and the connecting structure; and
post-processing the printed assembly to obtain the retainer base.
